(19) United States
(12) Patent Application Publication
(10) Pub. No.: US 2018/0149169 A1
(43) Pub. Date: May 31, 2018

(54) SUPPORT STRUCTURE FOR RADIAL INLET OF GAS TURBINE ENGINE

(71) Applicant: PRATT & WHITNEY CANADA CORP., Longueuil (CA)

(72) Inventors: Eric HO, Markham (CA); Jamal ZEINALOV, Mississauga (CA)

(21) Appl. No.: 15/365,392

(22) Filed: Nov. 30, 2016

(51) Int. Cl. F04D 29/42; F02C 3/04

(52) U.S. Cl. CPC F04D 29/4206; F05D 2260/30; F05D 2220/32; F02C 3/04

(57) ABSTRACT

The compressor inlet can have two walls forming an annular fluid path with a radial inlet end, and a support structure extending axially between the two walls, the support structure having a plurality of circumferentially-interspaced supports, each one of the plurality of supports extending freely between the two walls across the radial inlet end of the annular fluid path, each support having at least one node at an intermediary location between the two walls, at least one branch extending from the node to a first one of the walls, and at least two branches branching off from the node and leading to the second one of the walls.

### TECHNICAL FIELD

The application related generally to gas turbine engines and, more particularly, to a support structure for a radial inlet of a gas turbine engine.

### BACKGROUND OF THE ART

Compressor inlet support structures are designed to maintain structural integrity of the compressor inlet while supporting the assembly under structural and thermal loads experienced during typical mission conditions, or off-design, extreme conditions. In gas turbine engines having radial inlets, it was known to provide a support structure in the form of a plurality of circumferentially interspaced columns. The columns all extended along an axial orientation between opposite walls of the radial inlet. To minimize aerodynamic losses, the columns were typically airfoil shaped along the radial orientation. While these structures were satisfactory to a certain degree, there remained room for improvement in terms of stress distribution, peak stress, and/or weight.

### SUMMARY

In one aspect, there is provided a compressor inlet for a gas turbine engine, the compressor inlet having two walls forming an annular fluid path with a radial inlet end, and a support structure extending axially between the two opposite walls, the support structure having a plurality of circumferentially-interspaced supports, each one of the plurality of supports extending freely between the two walls across the radial inlet end of the annular fluid path, each support having at least one node at an intermediary location between the two walls, at least one branch extending from the node to a first one of the walls, and at least two branches branching off from the node and leading to the second one of the walls.

In another aspect, there is provided a gas turbine engine comprising, in serial flow communication, a compressor inlet, a compressor stage, a combustor, and a turbine stage, the compressor inlet having two walls leading to the compressor stage, and a support structure extending axially between the two walls, the support structure having a plurality of circumferentially-interspaced supports, each one of the plurality of supports extending freely between the two walls, each support having at least one node at an intermediary location between the two walls, at least one branch extending from the node to a first one of the walls, and at least two branches branching off from the node and leading to the second one of the walls.

### DESCRIPTION OF THE DRAWINGS

Reference is now made to the accompanying figures in which:

FIG. 1 is a schematic cross-sectional view of a gas turbine engine;

FIG. 2 is a schematic view illustrating loads on a compressor inlet;

FIG. 3 is a side elevation view of a first example of a compressor inlet with a support structure;

FIG. 4 is a side elevation view of a second example of a compressor inlet with a support structure;

FIG. 5 is a side elevation view of a third example of a compressor inlet with a support structure;

FIG. 6 is a side elevation view of a fourth example of a compressor inlet with a support structure.

### DETAILED DESCRIPTION

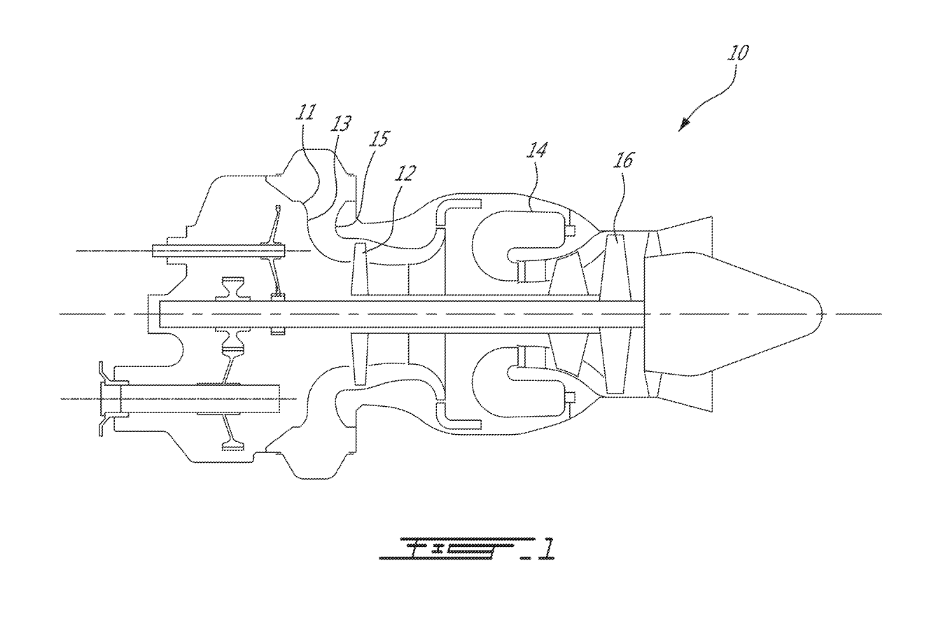

FIG. 1 illustrates an example of a turbine engine. In this example, the turbine engine 10 is a turboshaft engine generally comprising in serial flow communication, a compressor inlet 11, a multistage compressor 12 for pressurizing the air, a combustor 14 in which the compressed air is mixed with fuel and ignited for generating an annular stream of hot combustion gases, and a turbine section 16 for extracting energy from the combustion gases. The compressor inlet 11 has a generally annular structure having two opposite walls 13, 15 which guide the intake air from a generally radial orientation to a generally axial orientation.

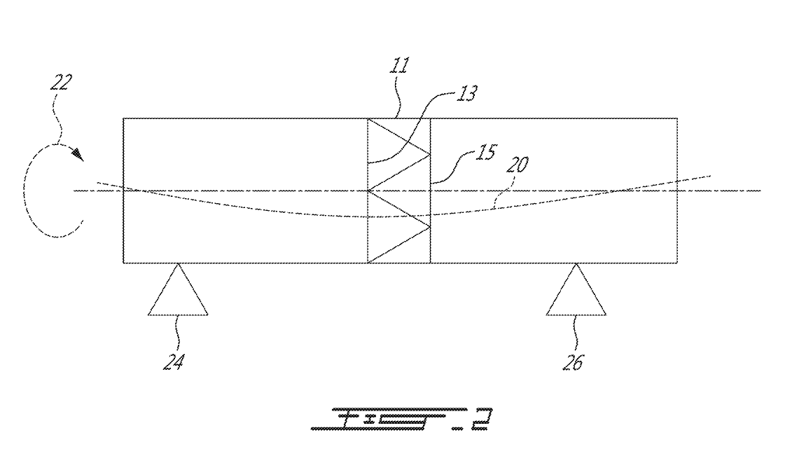

FIG. 2 schematizes example stresses to which the compressor inlet 11 can be subjected during use of the gas turbine engine 10. For instance, the compressor inlet 11 can be subjected to axial loads when the compressor inlet 11 is supported between two engine mounts 24, 26. In some circumstances only one engine mount location is present (24 or 26). Bending loads tend to deform the compressor inlet by bending, or curving the axis, such as schematized by curved axis 20 (exaggerated for the purpose of clarity). Such bending loads can be experimented during vibrations, manoeuvres and shocks (e.g. landing), and can be influenced by the weight of the engine.

The compressor inlet 11 can also be subjected to moment loads 22. Such moment loads represent a relative torsion around the axis of the engine between two components, and can be experimented during vibrations, and be influenced by the operation of the engine, for instance. For instance, a torsion can occur between the first wall 13 and the second wall 15 of the turbine engine 10.

The compressor inlet 11 can also be subjected to thermal loads. One source of thermal loads is heat expansion/contraction of the components during different scenarios (e.g. high altitude cruising, sea level parking, takeoff).

FIG. 3 shows an example of a compressor inlet 11 for a gas turbine engine 10 having a radial inlet. The compressor inlet 11 has a support structure 30 having plurality of circumferentially interspaced columns 32. The columns 32 all extend along an axial orientation, between opposite walls 13, 15 of the compressor inlet. To minimize aerodynamic losses, the columns 32 can be airfoil shaped along the radial orientation, so as to offer minimal resistance to the incoming radial airflow. The columns 32 have a given radial depth 36 and a given axial length 34. The radial depth of the columns 32 extend from a radially outer portion of the compressor inlet 11, and radially into the compressor inlet 11, along a curved portion of the wall 15 which transitions the incoming flow from radial to axial. The radial length of the columns is comparable to the axial length of the columns 32, and the columns 32 have an associated weight.

In one embodiment, engineering knowledge was used in conjunction with computer-assisted analysis using topology optimization techniques in a manner to evaluate the possibility of further optimizing features such as peak load, load distribution, and weight of the support structure 30. In the example presented below, the analysis was conducted using the software tool Inspire™ which can be obtained from solidThinking, inc., an Altair company.

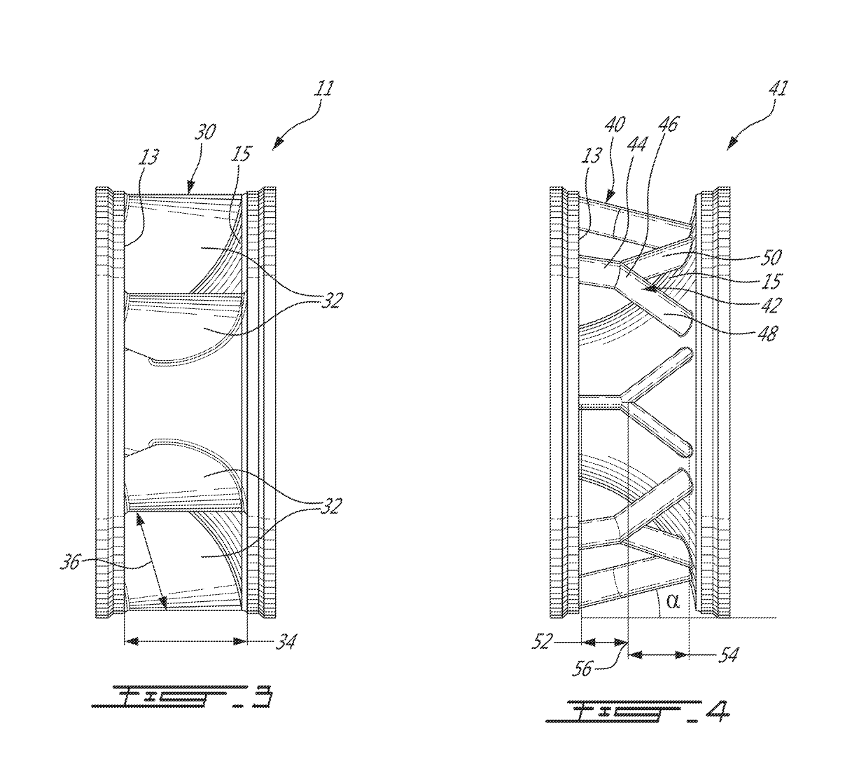

In a first scenario, the compressor inlet 11 was analyzed in a scenario dominated by axial and bending loads for both mission and off design conditions. A support structure was designed which could satisfactorily withstand the structural and thermal loads, while minimizing weight and stress and optimizing stress distribution. For the same general compressor inlet configuration as the one shown in FIG. 3, the design technique led to the support structure 40 shown in FIG. 4.

In the support structure 40 shown in FIG. 4, the support structure 40 includes a plurality of identical supports 42 which are each circumferentially interspaced from one another. The supports 42 extend freely from a first wall 13 of the compressor inlet 41 to a second wall 15 of the compressor inlet 41. The supports 42 can be said to have a length extending from the first wall 13 to the second wall 15, and a width which extends circumferentially. The supports 42 are all identical. The supports 42 have a first branch 44 leading from the first wall 13 to a node 46, and two branches 48, 50 branching off from the node 46 and leading to the second wall 15, forming a fork. Overall, the supports 42 in FIG. 4 can be seen to generally have a Y shape. The first one of the branches 44 has a length 52 which is shorter than an axial length 54 of the two other branches 48, 50, and the intermediary location 56 of the node 46 can be seen to be closer to the first wall 13 than to the second wall 15. The length of the supports is generally oriented axially, and is also inclined relative to an axial orientation in the radially-inner direction along angle α, from the first wall 13 to the second wall 15.

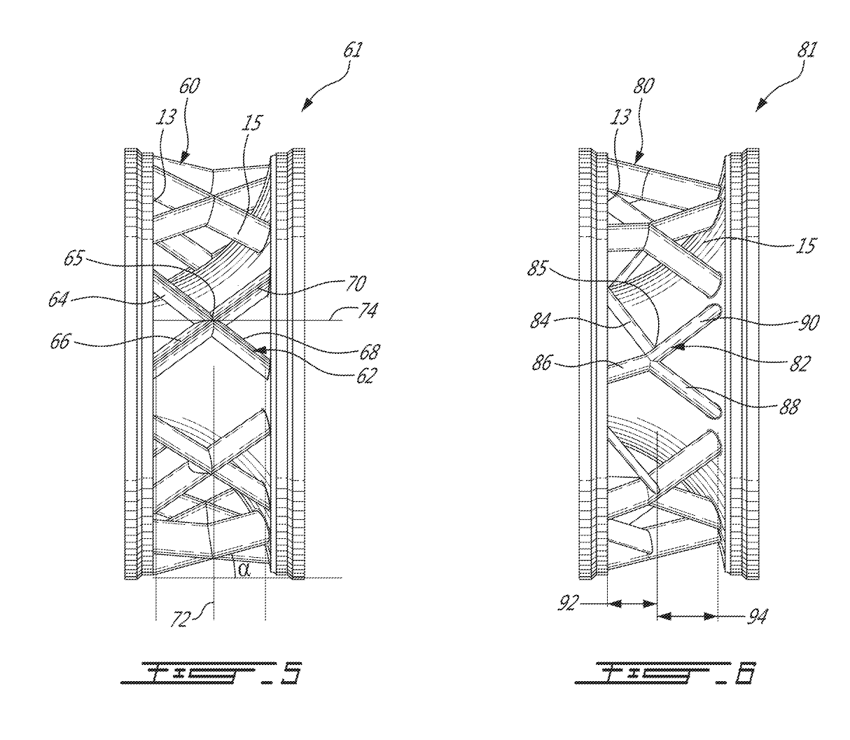

In a second scenario, the compressor inlet 11 was analysed in a scenario dominated by moment loads for both mission and off design conditions. The design technique was used to generate a support structure shape which could satisfactorily withstand the moment loads, while minimizing weight and stress and optimizing stress distribution. For the same general compressor inlet configuration as the one shown in FIGS. 3 and 4, the design technique led to the support structure 60 shown in FIG. 5.

In the support structure 60 shown in FIG. 5, the support structure 60 also includes a plurality of identical supports 62 which are each circumferentially interspaced from one another. The supports extend freely from a first wall 13 of the compressor inlet 61 to the second wall 15 of the compressor inlet 15. The supports 62 extend generally in an axial orientation. The supports have two branches 64, 66 leading from the first wall to a node 65, and two branches 68, 70 branching off from the node 65 and leading to the second wall 15, forming two opposed forks, or a general X-shape. In this embodiment, the supports 62 are symmetrical both along a radially-axial plane 72 and along a radially-transversal plane 74. The intermediary location 72 of the node can be seen to be halfway between the first wall 13 and the second wall 15. The length of the supports is inclined relative to an axial orientation in the radially-inner direction along angle α, from the first wall 13 to the second wall 15.

In a third scenario, the compressor inlet was analysed in a scenario of balanced moment and axial loads for both mission and off design conditions. The design technique was used to generate a support structure shape which could satisfactorily withstand the moment loads, while minimizing weight and stress and optimizing stress distribution. For the same general compressor inlet configuration as the one show in FIGS. 3-5, the design technique led to the support structure 80 shown in FIG. 6.

In the support structure 80 shown in FIG. 6, the support structure 80 also includes a plurality of identical supports 82 which are each circumferentially interspaced from one another. The supports 82 extend freely from a first wall 13 to the second wall 15 of the compressor inlet 81. The supports 82 extend generally in an axial orientation. Each support has main branches 86, 90 and secondary branch 84, 88 branching off from the node 85 to a corresponding wall 13, 15, on each axial side of the node 85. The secondary branches 84, 88 have a smaller cross-sectional area than the corresponding main branch 86, 90, and the relative circumferential directions of the main branch 86, 90 and of the secondary branch 84, 88 are inversed on the first side and on the second side. As seen, the main branch slopes downwardly on the left side, and upwardly on the right side in FIG. 6. The main branches 86, 90 are used for compression resistance, whereas the secondary branches 84, 88 are used for tension resistance. In this specific embodiment, both the main branch 86 and the secondary branch 84 are shorter on a side of the node 85 leading to the first wall 13, compared to the main branch 90 and the secondary branch 88 on the side of the node 85 leading to the second wall 15. The distance 92 between the first wall 13 and the node 85 is smaller than the distance between 94 the second wall 15 and the node 85. The length of the supports is inclined relative to an axial orientation in the radially-inner direction, from the first wall 13 to the second wall 15.

The shapes presented above can be further adapted to different embodiments of compressor inlets, and to different mission and off design conditions. For instance, icing, inlet distortion and noise can be taken into consideration in the determination of a particular support structure design.

Moreover, the structures can have different shapes in different embodiments. For instance, instead of having two branches leading from a node to a given wall, in a different embodiment, the supports can have three branches leading from a node to a given wall. A three branch embodiment can include two branches positioned adjacent the edge of the radial inlet, and sloping circumferentially relative to each other, and a third branch sloping in a radially-inward direction relative to the other two. Still other configurations are possible.

In practice, the branches will typically be hollow, which can provide weight reduction for a given mechanical resistance. The hollow branches can form a continuous gas path extending inside the support structure, and this gas path can be used to circulate hot air during use, to help withstand icing, if desired. The exact cross-sectional shape of the branches can be selected in a manner to optimize noise and aerodynamic performance. The cross-sectional shape and size can vary along a length of the branches to further reduce areas of peak stress and even out stress distribution. The supports can be formed by any suitable manufacturing process, such as casting or additive manufacturing (e.g. 3D printing), and can involve post processing.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A compressor inlet for a gas turbine engine, the compressor inlet having two walls forming an annular fluid path with a radial inlet end, and a support structure extending axially between the two opposite walls, the support structure having a plurality of circumferentially-interspaced supports, the supports extending freely between the two walls across the radial inlet end of the annular fluid path, the supports having at least one node at an intermediary location between the two walls and a plurality of branches extending therefrom, at least one of said branch extending from the node to a first one of the walls, and at least two of said branches branching off from the node and leading to the second one of the walls.

2. The compressor inlet of claim 1 wherein at least one support has said branches arranged in a Y shape, with a single branch leading from the node to the first wall and two branches extending from the node to the second wall.

3. The compressor inlet of claim 2 wherein the single branch is closer to the compressor stage than the two branches extending from the node to the second wall.

4. The compressor inlet of claim 1 wherein at least one support has said branches arranged in an X-shape, with two branches extending from the node to the first wall and two branches extending from the node to the second wall.

5. The compressor inlet of claim 4 wherein the X-shape is symmetrical relative to a line through the node.

6. The compressor inlet of claim 1 wherein at least one support has a main branch and a secondary branch branching off from the node to a corresponding wall on each axial side of the node, wherein both secondary branches have a smaller cross-sectional area than the corresponding main branch, and wherein the relative circumferential directions of the main branch and of the secondary branch are inversed on the first side and on the second side.

7. The compressor inlet of claim 6 wherein both the main branch and of the secondary branch are shorter on a side of the node leading to the first end than the main branch and the secondary branch on the side of the node leading to the second end.

8. The compressor inlet of claim 1 wherein the support structures are positioned adjacent the radial inlet end of the compressor inlet.

9. The compressor inlet of claim 1 wherein the support structures have a length between the first wall and the second wall, the length of the support structure being inclined relative to an axial orientation.

10. A gas turbine engine comprising, in serial flow communication, a compressor inlet, a compressor stage, a combustor, and a turbine stage, the compressor inlet having two walls leading to the compressor stage, and a support structure extending axially between the two walls, the support structure having a plurality of circumferentially-interspaced supports, the supports having at least one node at an intermediary location between the two walls and a plurality of branches extending therefrom, at least one of said branch extending from the node to a first one of the walls, and at least two of said branches branching off from the node and leading to the second one of the walls.

11. The gas turbine engine of claim 10 wherein at least one support has said branches arranged in a Y shape, with a single branch leading from the node to the first wall and two branches extending from the node to the second wall.

12. The gas turbine engine of claim 11 wherein the single branch is closer to the compressor stage than the two branches extending from the node to the second wall.

13. The gas turbine engine of claim 10 wherein at least one support has said branches arranged in an X-shape, with two branches extending from the node to the first wall and two branches extending from the node to the second wall.

14. The gas turbine engine of claim 13 wherein the X-shape is symmetrical relative to a line through the node.

15. The gas turbine engine of claim 10 wherein at least one support has a main branch and a secondary branch branching off from the node to a corresponding wall on each axial side of the node, wherein both secondary branches have a smaller cross-sectional area than the corresponding main branch, and wherein the relative circumferential directions of the main branch and of the secondary branch are inversed on the first side and on the second side.

16. The gas turbine engine of claim 14 wherein both the main branch and of the secondary branch are shorter on a side of the node leading to the first end than the main branch and the secondary branch on the side of the node leading to the second end.

17. The gas turbine engine of claim 10 wherein the support structures are positioned adjacent the radial inlet end of the compressor inlet.

18. The gas turbine engine of claim 10 wherein the support structures have a length between the first wall and the second wall, the length of the support structure being inclined relative to an axial orientation.
